(19) United States
(12) Patent Application Publication
(10) Pub. No.: US 2017/0046714 A1
(43) Pub. Date: Feb. 16, 2017

(54) BIOMETRIC VERIFICATION METHOD AND SYSTEM

(71) Applicant: MasterCard International Incorporated, Purchase, NY (US)

(72) Inventors: Eddy Van de Velde, Leuven (BE); Mohamed Abou El Enin, Brussels (BE); Sumeet Bhatt, Jericho, NY (US)

(21) Appl. No.: 15/234,281

(22) Filed: Aug. 11, 2016

(30) Foreign Application Priority Data
Aug. 11, 2015 (GB) 1514201.1
Feb. 26, 2016 (GB) 1603408.4

(51) Int. Cl. G06Q 20/40; H04L 29/06

(52) U.S. Cl. CPC G06Q 20/40145; H04L 63/083; H04L 63/0861

(57) ABSTRACT

A method of biometric verification is described involving interaction between a token and a terminal. The token stores, or has access to, stored user biometric data. The terminal has an associated biometric reader. User biometric data is captured at the biometric reader. The token then initiates comparison of the captured user biometric data with the stored user data to determine a match. The token provides a verification result to the terminal, wherein an action at the terminal may proceed if the verification result indicates a match between the captured user biometric data and the stored biometric data. Methods performed at the token and at the terminal are described, as are tokens and terminals adapted to perform the steps described.

### CROSS-REFERENCE TO RELATED APPLICATIONS

This application is a U.S. National Stage filing under 35 U.S.C. §119, based on and claiming benefits of and priorities to GB Provisional Patent Application No. 1603408.4 filed Feb. 26, 2016 and GB Provisional Patent Application No. 1514201.1 filed Aug. 11, 2015.

### FIELD OF DISCLOSURE

The present disclosure relates to a biometric verification method and system. In embodiments, the approach described involves use of a token holding biometric information of a user and a terminal adapted to read biometric information from the user.

### BACKGROUND OF DISCLOSURE

Biometric verification is widely used to verify users in various contexts. Typically, a verification system involves previously captured and verified user biometric data (such as a fingerprint, an iris scan, a facial image or a voiceprint), a biometric capture device and a matching system to determine whether there is a match between the verified user biometric data and captured biometric data from the capture device. Biometric verification may be used, for example in determining whether a permitted user wishes to gain access to a computing device.

There is an increasing wish to support biometric verification for payment transactions made with a payment device such as a payment card comprising a chip (such as those designed to operate according to EMV technical standards).

Typically, a payment card is held by a cardholder and interacts with terminals (such as point of sale terminals or automated teller machines) associated with a financial institution whereby transactions are mediated by a transaction infrastructure associated with the card type. Any such solution should be technically effective, cost effective, secure, and of limited consequences for existing standards and the installed base of payment cards and terminals.

### SUMMARY OF DISCLOSURE

In a first aspect, the invention provides a method of biometric verification for a transaction, the method comprising interaction between a token having user biometric data stored thereon or accessible therethrough and a terminal having a biometric reader associated therewith, the method comprising:
user biometric data being captured at the biometric reader;
the token initiating comparison of captured user biometric data with the stored user data to determine a match; and
a verification result being provided to the terminal, wherein the transaction may proceed if the verification result indicates a match between the captured user biometric data and the stored biometric data.

Preferably, comparison takes place at the token, and the token obtains the verification result and returns it to the terminal. The token may achieve this by using a dedicated application for biometric verification that may be called on as a service by a transaction application on the token. Preferably, the token and the terminal first determine whether both support biometric verification—if both support biometric verification, the terminal may require the token to perform biometric verification. If one party does not support biometric verification (or the same biometric verification protocol) then another verification method may be used. The token may be a payment device, such as a payment card, particularly a payment card implementing EMV technical standards. In this case, biometric verification may be treated as a permissible cardholder verification method (CVM) in the context of the EMV technical standards. In embodiments, the combination of multiple cardholder verification strategies is described, allowing for example use of a user PIN if biometric verification is not possible. The terminal may be a point of interaction for a payment infrastructure, such as that operated by a payment card provider for card issuing and transaction acquiring banks. However, in other embodiments the transaction may be a non-financial transaction—the terminal may also be a multi-use terminal with both financial and non-financial uses.

In a further aspect, the invention provides a payment device adapted to implement token functions as described in the method set out above. This may be a payment card, particularly a payment card implementing EMV technical standards. Biometric verification may be provided separately from a payment application, but the payment application may then be modified to allow biometric information of a predetermined format to be matched and a verification result used as verification in the payment application. In this way a hierarchy of verification options may be implemented, allowing for example biometric verification to be performed if possible for verification, and if not possible, for a customer PIN to be used. In embodiments, biometric reference data on the card can be updated using EMV scripting mechanisms adapted for extended data length and to fit within existing hardware security modules.

In a still further aspect, the invention provides a terminal of a transaction infrastructure adapted to perform terminal functions as described in the method set out above. As noted above, the terminal may be a point of interaction for a payment infrastructure, such as that operated by a payment card provider for card issuing and transaction acquiring banks.

### BRIEF DESCRIPTION OF FIGURES

Embodiments of the disclosure will now be described, by way of example, with reference to the accompanying Figures, of which:

FIG. 1 shows an exemplary transaction system in which embodiments of the present disclosure may be used;

FIG. 2 is a block diagram illustrating the elements of a payment card as used in the transaction system of FIG. 1;

FIG. 3 is a schematic diagram illustrating the elements of a point of interaction terminal as used in the transaction system of FIG. 1;

FIG. 4 illustrates schematically system elements and interactions in an embodiment of the disclosure;

FIG. 5 illustrates an exemplary transaction flow for the arrangement of FIG. 4;

FIG. 6A and FIG. 6B are flow diagrams that illustrate modifications to the customer verification method used at a terminal according to an embodiment of the disclosure;

FIG. 7 is a flow diagram illustrating biometric verification handler logic applicable to the biometric verification handler of FIG. 4;

FIG. 8 is a flow diagram demonstrating modified First GENERATE AC command logic in embodiments of the disclosure by adaptation of existing EMV specification process flows;

FIGS. 9A and 9B are flow diagrams demonstrating modified Second GENERATE AC command logic in embodiments of the disclosure by adaptation of existing EMV specification process flows;

FIGS. 10A and 10B are flow diagrams demonstrating modified GET DATA and PUT DATA command logic respectively in embodiments of the disclosure by adaptation of existing EMV specification process flows;

FIGS. 11A to 11L are flow diagrams demonstrating PIN management in embodiments of the disclosure by adaptation of existing EMV specification process flows;

FIG. 12 is a flow diagram demonstrating cardholder verification in embodiments of the disclosure by adaptation of an existing EMV specification process flow; and

FIGS. 13A to 13E are flow diagrams demonstrating in detail cardholder verification for encrypted biometric data in embodiments of the disclosure by adaptation of existing EMV specification process flows.

### DESCRIPTION OF SPECIFIC EMBODIMENTS

As will be discussed below, embodiments of the disclosure may be used in a variety of technical contexts. The main embodiment described here is a transaction system in which a cardholder interacts with a terminal according to the conventional four-party model, but as the skilled person will appreciate, the approach taught here may apply to any system in which a user equipped with a token having processing capabilities and bearing biometric data interacts with the terminal of a system to allow the user access to that system. This may apply to access control for buildings, interaction with transit systems, and many other contexts.

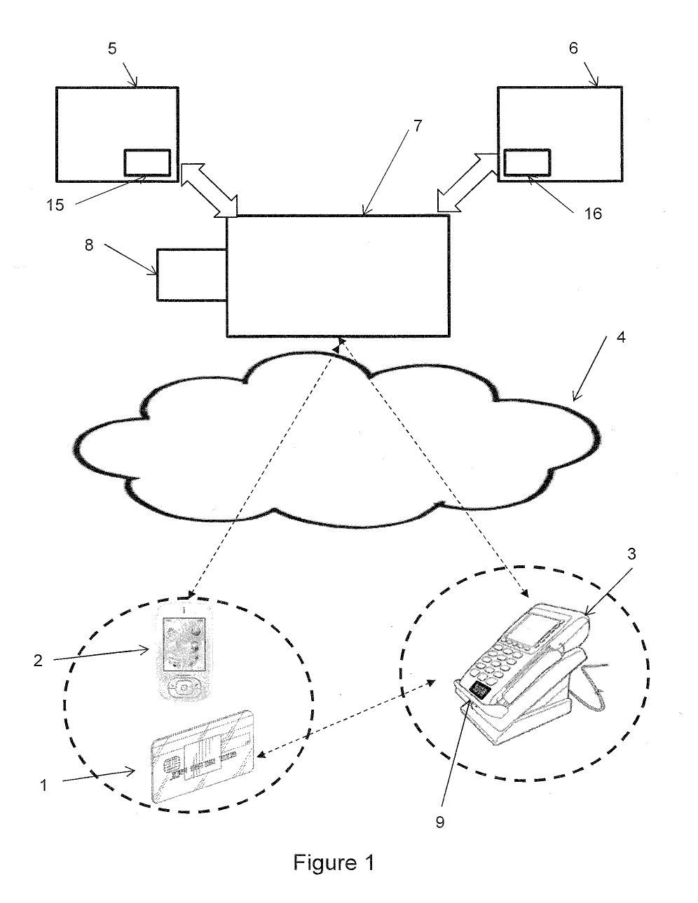

FIG. 1 shows schematically relevant parts of a transaction system suitable for implementing an embodiment of the disclosure. This transaction system follows the four-party model, involving a customer (cardholder) transacting with a merchant. The cardholder is supported by an issuer (card issuing bank) and the merchant by an acquirer (acquiring bank), with the transaction system enabling the interaction operated by a transaction system provider.

To perform a transaction, a customer interacts with a merchant. A payment card 1 (in embodiments this may be another payment device such as a mobile phone 2 acting as a virtual card, or as a proxy of a physical card) of the customer interacts with a point of sale (POS) terminal 3 of the retailer to perform a transaction. The payment card 1 is associated with a customer account with a card issuer 5. A similar interaction may take place between a payment card 1 and another kind of terminal of the transaction system, such as an ATM. In the arrangement of this embodiment, the terminal 3 comprises an integral biometric reader 9 in the form of a fingerprint scanner. In other embodiments, the biometric reader may be another form of reader (such as a retinal scanner or voice recognition system) and need not be integral with the terminal 3, though should be connected to the terminal 3 in such as way that the terminal 3 can trust data received from the biometric reader 9 as being reliable and free from subversion.

The terminal 3 interacts with the transaction infrastructure 7 and directly or (as shown here) indirectly with a card issuer 5 for the customer and an acquiring bank 6 for the merchant over a suitable network 4—network 4 here represents any appropriate communication network or combination of networks for the communication path indicated, and may be the public internet, a cellular communications network or a private network, depending on the parties involved in the communication and the need for the communication path to be secure.

Value is transferred between the customer's bank (the issuing bank or issuer 5) and the merchant's bank (the acquiring bank or acquirer 6). The transaction is passed to the acquirer 6 and the issuer 5 through a transaction infrastructure 7—this achieves the necessary switching to direct transaction information appropriately, and is also associated with one or more data centres 8 controlling and monitoring the transaction process on behalf of the transaction infrastructure provider. The transaction is authorised by the issuer 5, typically according to rules established by the transaction infrastructure provider.

The payment device may operate under a contact or contactless protocol for communication with a point of interaction (POI) terminal such as a point of sale (POS) terminal or an automated teller machine (ATM). If used as a contactless device, the payment device includes a chip and a wireless transmitter and receiver adapted for short range communication by protocols such as those defined under ISO/IEC 14443.

The transaction infrastructure 7 connects the terminal 3, the card issuer 5 and the acquiring bank 6. This banking infrastructure will typically be provided by a transaction card provider who provides transaction card services to the card issuing bank 5. The transaction infrastructure 7 provides authorization at the time of purchase, clearing of the transaction and reconciliation typically within the same working day, and settlement of payments shortly after that. The banking infrastructure 7 comprises a plurality of switches, servers and databases, and most features of this infrastructure are not described further here where these are not necessary for understanding how embodiments of the disclosure function and may be implemented. A transaction infrastructure server 8 is however shown as associated with the transaction infrastructure and responsible for management and monitoring of the transaction infrastructure. The card issuer 5 has an issuer server 15 for interactions with the transaction system and the acquiring bank 6 has an acquirer server 16 for such interactions as well.

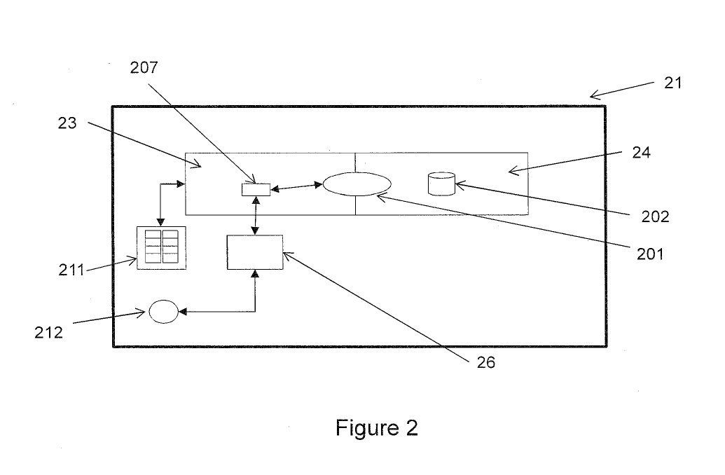

FIG. 2 shows schematically relevant parts of a representative hardware and software architecture for a transaction card such as a payment card 21 (particularly an EMV payment card) suitable for implementing an embodiment of the disclosure. The payment card 21 comprises an application processor 23, one or more memories 24 associated with the application processor and a NFC controller 26. The payment card 21 is equipped with a contact pad 211 for contact transactions using contact card protocols such as ISO/IEC 7816 and also comprises an antenna 212 connected to NFC controller 26 to allow transactions under contactless card protocols such as those defined under ISO/IEC 14443.

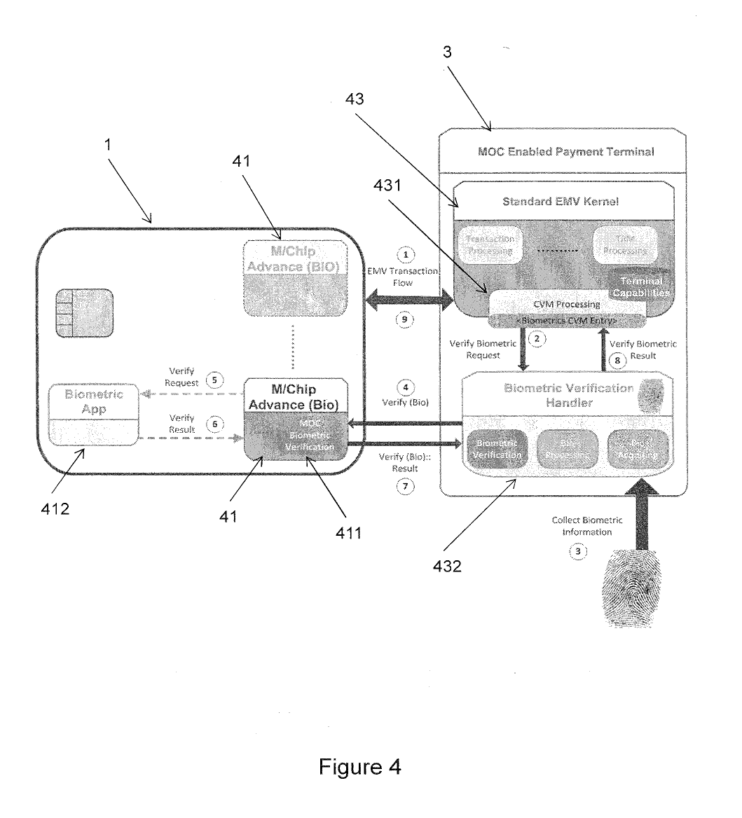

In the arrangement shown, the application processor 23 and associated memories 24 comprise (shown within the processor space, but with code and data stored within the memories) a transaction application 201, in this case adapted to perform transactions according to relevant EMV standards. This is exemplary of applications for execution on the card—these will be described further in FIG. 4 below. The memories 24 contain a storage location 202 for cardholder biometric data—this data is preferably stored securely so that its integrity can be trusted. Storage location 210 may thus be at least logically protected, or both physically and logically protected (for example in a hardware storage module)—it may for example use the same storage as keys used by the card in EMV processes, but may instead be held in a form which can be verified by another party (for example, signed by a third party trusted across the transaction system).

The application processor 23 provides an NFC application 207 which interfaces with the NFC controller 26. A transaction may be performed over a contact card interface, a contactless card interface, or any other communication channel available to the card for communicating with a terminal (either general purpose or dedicated to this purpose).

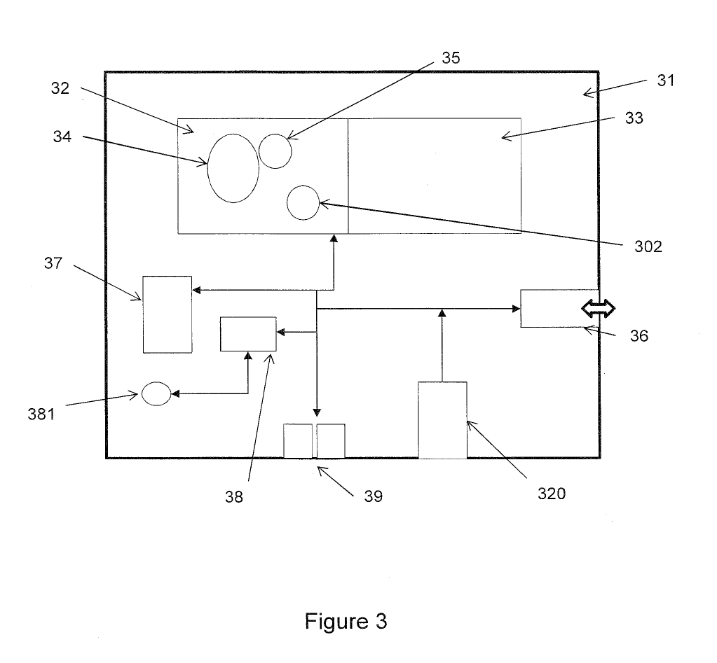

FIG. 3 illustrates the functional features of a terminal for use in embodiments of the disclosure in more detail. The terminal 31 has a processor 32 and associated memories 33. The base function of the terminal in the case shown is to operate as a point of interaction (POI) with a financial system—such a terminal may be a point of sale (POS) terminal or an automated teller machine (ATM) for example. In other embodiments, the terminal may have another function altogether (for example, a security system terminal for evaluating user credentials). In the case shown, the terminal 31 has an operating system 34 and transaction software 35 (these may be provided together in a single assemblage of code, or may both be divided into a number of different components, but are represented here as two elements for convenience). The operating system 34 manages hardware resources and provides common services for applications, whereas the transaction software 35 performs the base function of the terminal and may be provided (for example) as one or more applications. The terminal 31 will generally have a protected channel 36 to another party such as an acquiring bank (this may, for example, be effected over a public network by use of encryption)—embodiments of the invention have particular value in situations where this protected channel 36 is only sporadically available to the terminal 31. The terminal 31 will also have means to make a connection to a device such as a transaction card. In this case, the terminal has a contact card reader 37 and an NFC controller 38 and antenna 381 to allow a contactless card connection to a contactless card, or a device such as an NFC-enabled mobile telephone able to act as a proxy for a contactless card. The terminal 31 may have additional ports 39 to allow data to be provided to it from other sources (for example, by USB stick). Transactions may be established through the contact card reader 37 or through the NFC controller 38, or indeed any other appropriate local connection.

In this case, the terminal 31 also comprises an integral biometric reader 320—this may be for example a fingerprint reader. The biometric reader 320 is used to obtain a biometric result from a user interacting with the terminal 31—in embodiments described here, this user will be the cardholder of a payment card 21. An associated biometric application 302 is provided in the main operating environment of the terminal 31 to enable the biometric reader to be used to obtain a biometric result, though in embodiments the biometric reader 320 may be self-contained, running its own application in its own operating environment, and simply providing a biometric result to other applications in the terminal.

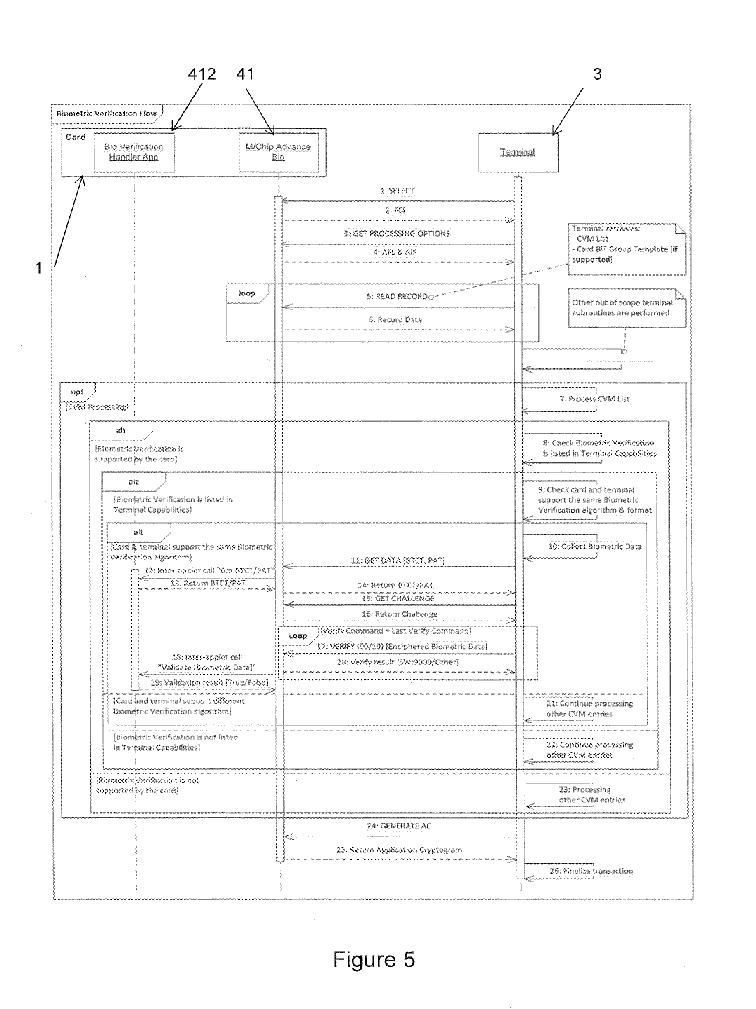

FIG. 4 illustrates the functional elements of a biometric verification system according to an embodiment of the disclosure, and also illustrates functional steps in a biometric verification system according to an embodiment of the disclosure (functional steps in EMV implementations are described in more detail with respect to FIGS. 5 to 10).

Before describing the elements of FIG. 4, basic operating principles of the embodiment will be discussed as follows.
The card has a single instance of reference biometric data to be used in verification. In principle, more reference biometric data could be used, but this would require a process for determining which biometric data should be used in a given context—the person skilled in the art will appreciate that this could be performed by an application selection negotiation between the terminal and the card if required (for example, the user could have reference biometric data for several reader types, and the selection process could establish which was appropriate to the terminal biometric reader).
The card biometric data are stored in an application that is separate and distinct from the payment application, here called the Biometric Application 401.
The Biometric Application maintains a verification try counter (BTC), performing a similar function to the PIN try counter in EMV specifications.
The card may contain multiple payment applications or multiple instances of the same payment application.
The cards falls back to standard CVM processing when presented to standard terminals that do not support biometric verification. Biometric verification in the arrangement shown takes place only when supported by both card and terminal—if either does not support biometric verification then standard customer verification methods are used.

In order to support biometric verification, in the embodiment described here the card and the terminal architecture are defined as consisting of a set of components. Each component may have subcomponents. FIG. 4 illustrates the different components and their interaction during a payment transaction with biometric verification.

A transaction application for use in conventional transactions is M/Chip Advance—this is adapted to perform a transaction with a terminal using EMV protocols. M/Chip Advance provides the applicant's implementation of the EMV standards for smart payment cards—EMV specifications can be found at https://www.emvco.com/specifications.aspx. EMV specifications implement standards based on ISO/IEC 7816 for contact cards, and standards based on ISO/IEC 14443 for contactless cards. To support biometric verification, a modified transaction application 41 is used here, M/Chip Advance (Bio). There may be multiple instance of the modified transaction application 41 on the card—for example, to support different biometric verification types, with the relevant modified transaction application 41 selected by the terminal as part of an application selection process. In general terms, to perform biometric verification, the card is organized with a dedicated application for biometric verification to supplement the primary transaction application selected by the terminal for the transaction. If the terminal commands the transaction application to perform biometric verification, the card then ‘commissions’ a sub-application (i.e. calls out for a service) on the card.

The Biometric Application 412 (also termed Biometric Verification Handler Application below) on the card is responsible for performing a biometric verification process upon request from an authorized transaction application on the card. It verifies the biometric data passed by the transaction application to support the transaction, and returns the biometric verification result to this transaction application. Biometric verification is therefore a “match on card” process, providing the cardholder with assurance that the biometric verification process is satisfactory and maintaining cardholder control of reference biometric data. The Biometric Application 412 may be unique on the card and adapted to serve all transaction applications supporting biometric verification.

Similarly at the terminal 3, there is a conventional transaction kernel 43 with modification to support biometric verification, together with an additional element to perform the biometric verification process.

The transaction kernel 43 may be that used for performing payment transactions according to existing approaches—it may for example be an EMV standard kernel performing payment transactions according to EMV specifications—with modification to support a different customer verification method, biometric verification. The CVM processing module 431 in the transaction kernel 43 is updated to support biometric verification as described here.

To implement the biometric verification process, the transaction kernel invokes the Biometric Verification Handler 432. This is a software module that manages the cardholder biometric verification on the terminal. It receives a biometric verification request from the CVM processing module 431 of the transaction kernel 43 to manage the following:
acquisition of biometric verification data from cardholder;
processing of the acquired biometric data from the cardholder;
managing the biometric verification that is performed on the card;
and feeding the verification result back to the CVM processing module in the transaction kernel.

In general terms, the biometric verification process follows the steps shown by the labelled arrows in FIG. 4.

Step 1—A payment transaction starts in a conventional manner (for example, as defined in EMV specifications).

Step 2—If biometric verification is a CVM supported by both the card and the terminal, the transaction kernel 43 requests the Biometric Verification Handler 432 to perform biometric verification.

Step 3—The cardholder is requested to present their finger to the fingerprint reader 9 associated with the terminal 3 to perform fingerprint biometric verification. Other types of biometric verification could be supported, in which case a different biometric reader would be used.

Step 4—The Biometric Verification Handler 432 sends a verification command to the card 1 with biometric data after it has been collected from the cardholder and processed—for an EMV implementation, this may be an EMV VERIFY command.

Step 5—The modified transaction application 41 requests the Biometric Application 412 to verify the received biometric data.

Step 6—The Biometric Application 412 returns a biometric verification result to the modified transaction application 41.

Step 7—The modified transaction application 41 returns a biometric verification result to the Biometric Verification Handler 432 on the terminal 3.

Step 8—The Biometric Verification Handler 432 feeds the CVM processing module 431 on the terminal 3 with the biometric verification result.

Step 9—The payment transaction is resumed after finalizing CVM processing in the conventional manner (for example, as required under current EMV standards).

It should be noted that if biometric verification fails, steps 4 to 8 may be repeated until the biometric verification is one of successful, aborted or blocked on the card.

A full verification process flow implemented according to existing EMV protocols modified to support biometric verification is now described with reference to FIG. 5, showing functional steps and whether these steps involve the terminal 3, the modified transaction application 41 on the card and/or the biometric (verification handler) application 412 on the card. Relevant EMV specifications, particularly Integrated Circuit Card Specification for Payment Systems: Application Independent ICC to Terminal Interface Requirements, Version 4.3, November 2011 (EMV Book 1), Integrated Circuit Card Specification for Payment Systems: Security and Key Management, Version 4.3, November 2011 (EMV Book 2) and Integrated Circuit Card Specification for Payment Systems: Application Specification, Version 4.3, November 2011 (EMV Book 3) are found at https://www.emvco.com/specifications.aspx and are incorporated by reference herein to the extent permitted by applicable law. Terminology used below for commands corresponds to existing EMV terminology for all terms used in EMV specifications, and further definition may be found in these documents. A list of acronyms and abbreviations used in discussions below is found at the end of this description of specific embodiments.

The transaction flow illustrated in FIG. 5 can be described as follows—steps are in accordance with standard EMV processing except where indicated:

1. The terminal 3 sends a SELECT command to the M/Chip Advance Bio application.

2. The M/Chip Advance Bio application 41 responds with the FCI template.

3. The terminal sends a GET PROCESSING OPTIONS command to the M/Chip Advance Bio application.

4. The M/Chip Advance Bio application responds with the AFL and AIP to show which applications are supported and where relevant information is stored.

5. The terminal sends series of READ RECORD commands to read the records identified in the AFL.

6. The M/Chip Advance Bio application returns the record data. The records contain the CVM List and the Card BIT Group Template. At this point, standard EMV processing becomes modified by the additional CVM option provided by biometric verification.

7. The terminal 3 starts CVM processing by processing the CVM List returned by the M/Chip Advance Bio application that indicates the support of one or more offline biometric verification CVM Codes by the card 1.

8. The terminal 3 checks if the support of the offline biometric verification method is indicated in the Terminal Capabilities and Biometric Terminal Capabilities.

9. The terminal 3 checks if the card 1 and the terminal support the same biometric verification solution based on the information defined in the Card BIT Group Template returned by the card.

10. The terminal 3 collects the biometric data from the cardholder and processes the biometric data.

11. The terminal sends two GET DATA commands to the M/Chip Advance Bio application to retrieve the BTCT and PAT to establish procedures to be used if repeated verification attempts are needed.

12. The M/Chip Advance Bio application requests the BTCT and PAT from the Biometric Verification Handler Application (on the card) via an inter-applet call.

13. The Biometric Verification Handler Application returns the BTCT and PAT to the M/Chip Advance Bio application.

14. The M/Chip Advance Bio application forwards to the terminal the BTCT and PAT received from the Biometric Verification Handler Application.

15. The terminal sends a GET CHALLENGE command to the M/Chip Advance Bio application.

16. The M/Chip Advance Bio application returns a challenge that is used later in the processing to encipher the biometric data.

17. The terminal sends one or more VERIFY commands with CLA byte ‘00’ or ‘10’ including the enciphered biometric data to the M/Chip Advance Bio application.

18. The M/Chip Advance Bio application forwards the biometric data to the Biometric Verification Handler Application via an inter-applet call.

19. The Biometric Verification Handler Application returns to the M/Chip Advance Bio application the result of the verification of the biometric data.

20. The M/Chip Advance Bio application returns to the terminal the result of the verification of the biometric data.

21. If the terminal and the card do not support the same biometric verification solution, the CVM processing skips to the next CVM code in the CVM List if applicable.

22. If the Terminal Capabilities and Biometric Terminal Capabilities do not indicate support for one of the offline biometric verification methods supported by the card, CVM processing skips to the next CVM codes in the CVM List if applicable.

23. If no common offline biometric verification CVM is supported, CVM processing processes another CVM if applicable.

24. The terminal sends a GENERATE AC command to M/Chip Advance Bio

25. M/Chip Advance Bio returns the Application Cryptogram to the terminal

26. The terminal finalizes the transaction as defined in existing EMV specifications.

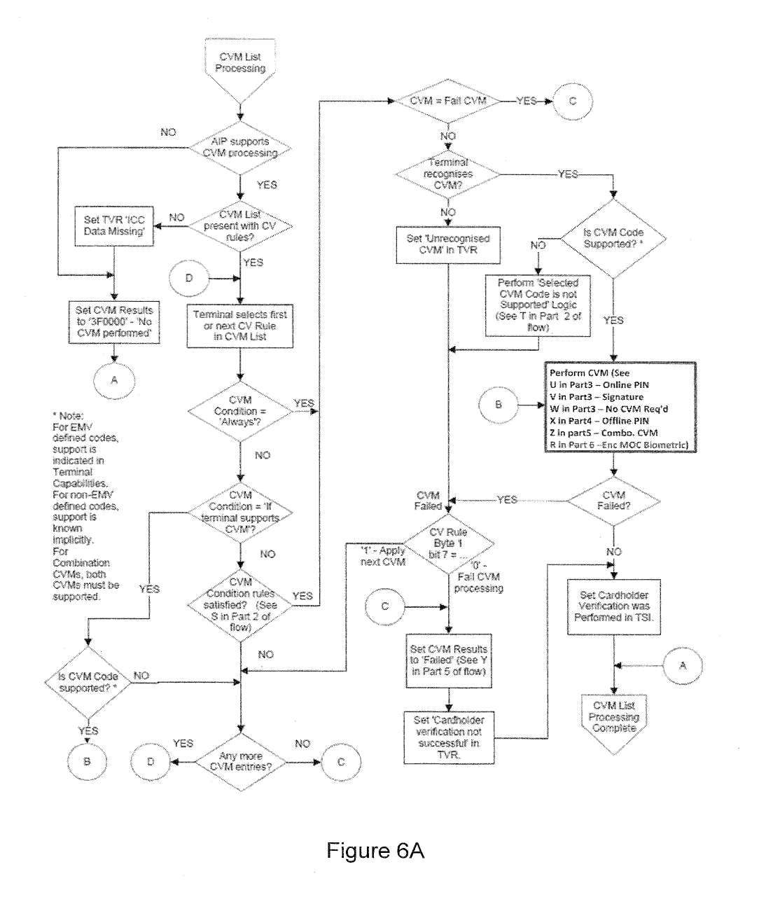

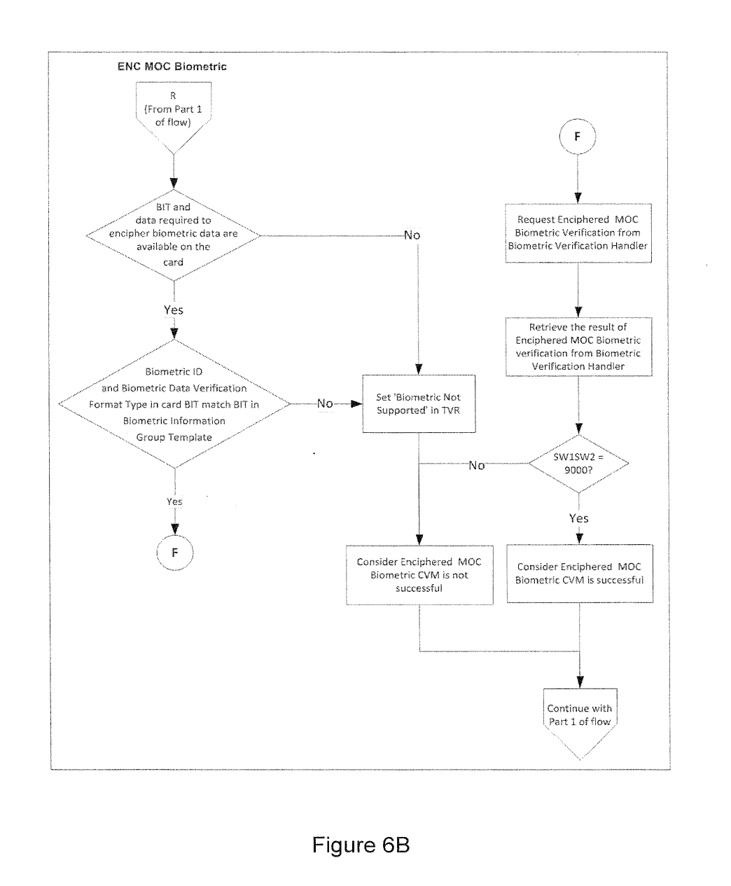

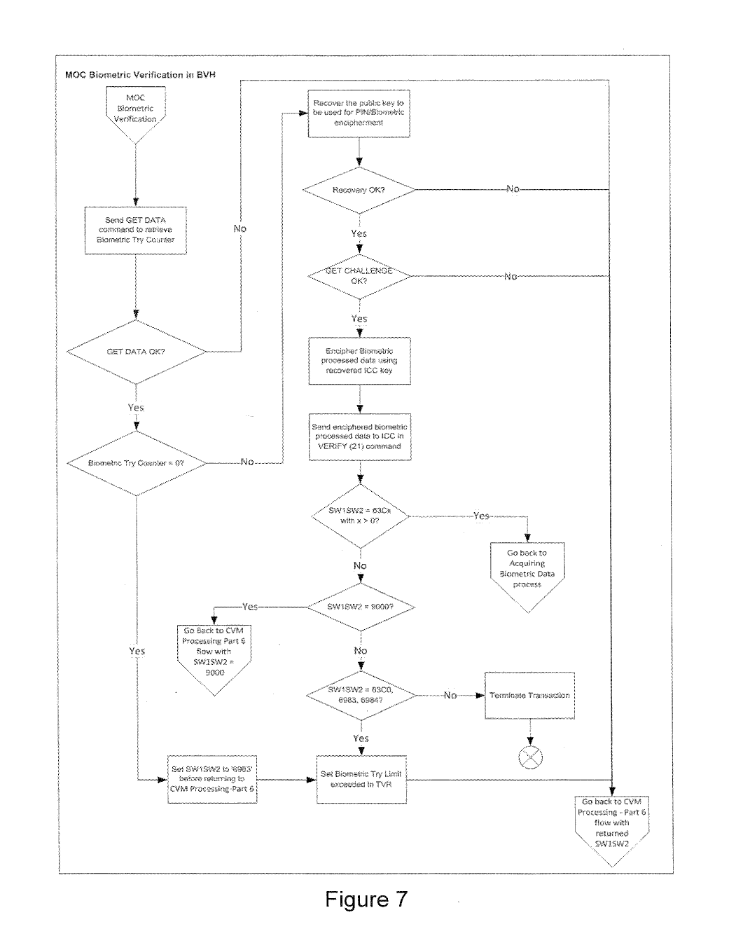

Processes at the terminal 3 in such an implementation will now be described in more detail with reference to FIGS. 6A, 6B and 7.

Existing EMV processing is modified by updating the CVM Processing module to handle Biometric MOC CVM (in particular enciphered Biometric MOC CVM), adding support for the Biometric Verification Handler to allow acquisition and processing of cardholder biometric data at the terminal and sending of the data to the card for verification and feeding the CVM Processing module with the match result from the card, and updating of the terminal data dictionary.

Modifications to CVM Processing module will now be discussed with reference to FIGS. 6A and 6B. The terminal CVM processing flow is updated to support Enciphered MOC Biometric CVM. The required updates may be summarized as follows:

1. Check if the Enciphered MOC Biometric CVM code is present in the CVM List and supported by the terminal as indicated in the Terminal Capabilities.

2. Check if the BIT and the Enciphered MOC Biometric CVM data are available on the card.

3. Check if the BIT mandatory data on the card matches one of the BITs listed in the Biometric Information Group Template of the terminal. Biometric ID and Biometric Data Verification Format Type on the card BIT must match one of the BITs listed in the Biometric Information Group Template.

4. Set the corresponding TVR bit if Biometric ID and Biometric Data Verification Format Type on the card BIT does not have a match with any of the BITs listed in the Biometric Information Group Template.

5. Request MOC biometric verification from Biometric Verification Handler when Enciphered MOC Biometric CVM is present in the CVM List and needs to be processed.

6. Receive the results of the MOC biometric verification from the Biometric Verification Handler.

7. Continue the processing of the CVM List according to the success or failure of the Enciphered MOC Biometric CVM.

In order to support Enciphered MOC Biometric CVM, the CVM processing logic as defined in section 10.5.5 of EMV Book 3 is updated as shown in FIGS. 6A and 6B. As shown in FIG. 6A which illustrates Part 1 of the flow, a new option is provided in the “Perform CVM” step to allow a new “Enc MOC Biometric” option. The flow for this is shown in the new Part 6 defining the encrypted match on card biometric verification flow shown in FIG. 6B.

The Biometric Verification Handler 432 on the terminal 3 will now be described further with reference to FIG. 7.

The Biometric Verification Handler is in this embodiment responsible for managing the biometric verification of a cardholder on the terminal. It manages the cardholder biometric verification upon receiving the biometric verification request from the CVM processing module 431 that is part of the transaction kernel 43. In order to verify the cardholder biometric data, the Biometric Verification Handler has the following functionalities:
Acquire biometric data: collects biometric data from cardholder
Process collected data: processes the collected data according to the format defined by the card BIT
Verify processed data: get the processed biometric data verified by the card.

Acquiring and processing biometric data and verifying processed data are described in more detail below.

In acquiring biometric data, the Biometric Verification Handler performs the following tasks:
1. Prompt the cardholder to present their biometric fingerprint data or other biometric data based on the card BIT information.
2. The terminal may update its prompts based on the values of Biometric Data Type and Biometric Sub-type stored in the card BIT.
3. Manage the communication with the biometric verification sensor for activation and deactivation of the sensor
4. Collect the biometric data from the sensor
5. Log the event in the TVR by setting the appropriate bit if:
   a. The biometric verification sensor is not working or present
   b. The biometric data is not acquired from the cardholder
6. Prepare the collected data to be processed.

The Biometric Verification Handler processes and reformats the collected biometric data from the cardholder in the format defined by the card BIT.

The Biometric Verification Handler requests the card to verify the cardholder processed biometric data as follows:

1. The Biometric Verification Handler checks if the BTC is exceeded and sets the corresponding bit in the TVR accordingly.

2. The Biometric Verification Handler uses either the ICC Public Key pair for offline dynamic data authentication or the ICC PIN Encipherment Public Key pair to encipher the biometric data in the same way as the PIN block is enciphered as defined in section 7 in EMV Book 2.

3. ICC PIN Encipherment Public Key Data is signed by the issuer and formatted as defined in section 7.1 in EMV Book 2.

4. ICC Public Key Data is signed by the issuer and formatted as defined in section 6 in EMV Book 2.

5. The first step of the encipherment of the biometric data is the retrieval of the public key to be used by the terminal. This process is defined in section 7.1 in EMV Book 2. for PIN encipherment.

6. The biometric data is enciphered in the same way as the PIN as defined in section 7.2 in EMV Book 2. with the following updates:
a. Update the length of Random Padding data to be: N-NBIO-9 bytes,
where N is the length in bytes of the public key to be used for PIN encipherment retrieved as specified in section 7.1 in EMV Book 2. (hence N=NPE or N=NIC) and NBIO is the length of biometric data.
b. Maximum Length of NBIO=239—Minimum Random Padding length.
c. Minimum Random Padding length is 12 bytes.
d. Table 25 in EMV Book 2 is updated as specified in Table 1 below.

TABLE 1
Data to be enciphered for Biometric Encipherment

| Field Name | Length | Description | Format |
|---|---|---|---|
| Data Header | 1 | Hex Value ‘7F’ | b |
| Biometric Data | N_{BIO} | Biometric data to be enciphered | b |
| ICC Unpredictable | 8 | Unpredictable number obtained | b |
| Number | | from the ICC with the GET | |
| | | CHALLENGE command | |
| Random Padding | N_{IC}-9- | Random Padding generated by | b |
| | N_{BIO} | the terminal | |

7. Biometric data encipherment continues as defined in section 7.2 in EMV Book 2 for PIN Encipherment.

8. The Biometric Verification Handler sends a VERIFY command to the selected application. The value field of the VERIFY command includes the enciphered biometric data together with any Biometric Matching Algorithm Additional Parameters that might be indicated in the BIT. The VERIFY command for MOC biometric verification is defined in Table 2 below.

TABLE 2
VERIFY command message for MOC Biometrics Verification

| Code | Value |
|---|---|
| CLA | ‘00’ |
| INS | ‘21’ |
| P1 | ‘00’ |
| P2 | See below |
| Lc | var. |
| Data | Biometric Verification Data |
| Le | Not present |

P2 is set as defined by ISO/IEC 7816-4. Table 3 indicates the values used for Enciphered MOC Biometric verification.

TABLE 3
VERIFY command qualifier P2 for templates

| b8 | b7 | b6 | b5 | b4 | b3 | b2 | b1 | Description |
|---|---|---|---|---|---|---|---|---|
| 1 | — | — | — | — | — | — | — | Global reference data |
| — | 0 | 0 | 0 | 1 | 0 | 0 | 0 | Enciphered template |
| — | x | x | x | — | x | x | x | RFU |

9. After sending the VERIFY command to the selected application on the card, the Biometric Verification Handler receives and manages the card biometric verification result.

10. If biometric verification is successful, it forwards the result to the CVM processing module in the EMV kernel to continue CVM Processing.

11. If biometric verification is not successful, the Biometric Verification Handler returns to the Biometric Data Acquiring process if BTC≠0 to retry biometric verification.

12. If biometric verification is not successful and BTC=0, the Biometric Verification Handler forwards the biometric verification result to the CVM Processing module in the EMV kernel to continue CVM processing with SW1SW2≠9000 as defined in FIG. 6B.

The biometric verification logic in the Biometric Verification Handler is shown in FIG. 7. Updates to the terminal data dictionary are not necessary for understanding of the operation of embodiments of the invention and are not described in detail here, as the nature of modifications required will be readily apparent to the person skilled in the art. In general, cardholder verification rules and terminal capabilities need to be modified to include MOC biometric verification as an option and terminal verification results need to be updated to include biometric options. A Biometric Information Group Template and a Biometric Information Template need to be added, along with a Biometric ID, Biometric Data Types (potentially with sub-types, such as different finger types as a sub-type of fingerprint scan), Biometric Data Format types and owners, and Biometric Try Counter and Biometric Try Limit.

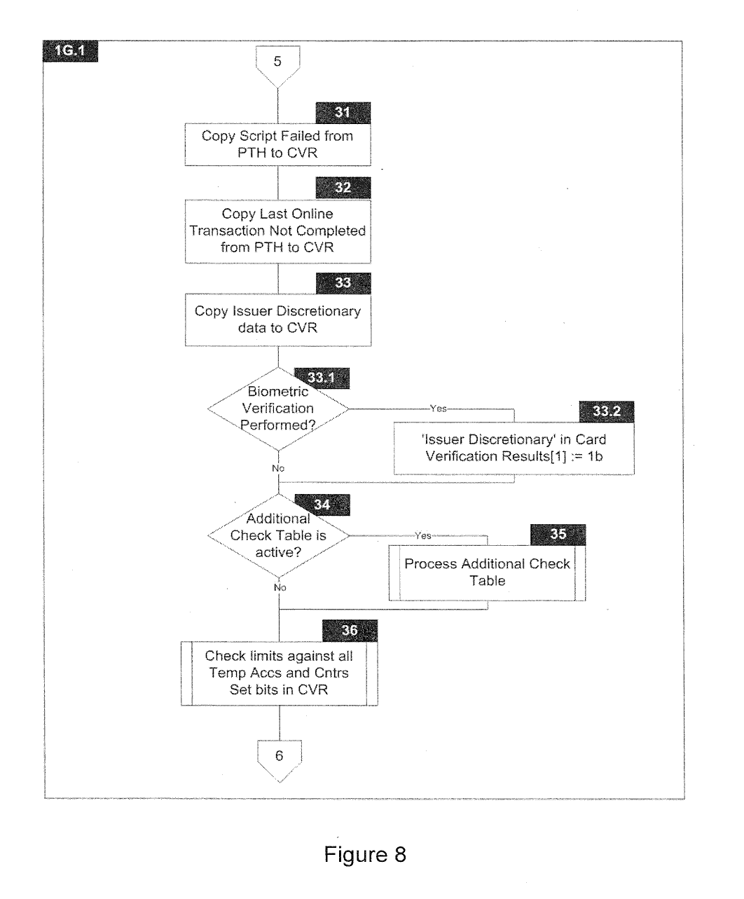

Implementation of the M/Chip Advance (Bio) and Biometric (Verification Handler) Application at the card will now be discussed. Features supported by each element will be generally described, then specific implementations of particular features and process flows discussed in more detail with reference to FIGS. 8 to 13.

M/Chip Advance (Bio) supports the following:

1—Identify and store a Biometric Application reference to be used for biometric verification.

2—Support the VERIFY command adapted for biometric MOC.

3—Establish inter-applet communication with the Biometric Application on the card.

4—Forward biometric data received in the VERIFY command to the Biometric Application for verification.

5—Provide to the terminal the result of the biometric verification returned by the Biometric Application.

6—In case of biometric verification failure, return to the terminal the latest BTC value returned by the Biometric Application.

7—Set a specific biometric CVR bit during the GENERATE AC command when VERIFY (21) is used to indicate that the last offline CVM performed by the terminal is Enciphered MOC Biometric CVM and not Offline PIN CVM.

8—Reuse the offline PIN verification bits in the CVR for biometric verification. The issuer host can then check the specific bit in the CVR to determine whether the PIN bits in the CVR are used for PIN verification or for biometric verification. As a consequence, the right nibble of BTC is copied into Byte 3 bit 1-4 in the CVR instead of PTC.

9—Reset the biometric CVR bit if a VERIFY (20) command is received to verify Offline PIN after a VERIFY (21) command is processed. Consequently, the PIN verification bits in the CVR are set based on the VERIFY (20) command processing (the last VERIFY command received).

10—Overload the parameters of PIN CHANGE/UNBLOCK command in order to allow the card issuer to reset the BTC and to update the cardholder reference biometric verification data that are stored in and managed by the Biometric Application.

11—Send a BTC reset request to the Biometric Application during the processing of the PIN CHANGE/UNBLOCK command when requested.

12—Send a request to update the cardholder biometric data to the Biometric Application during the processing of the PIN CHANGE/UNBLOCK command when requested.

13—Support the retrieval of the BTC and BTL with the GET DATA command

14—Support the update of the BTL with the PUT DATA command.

Issuers should thus be aware of the following characteristics of the M/Chip Advance (Bio) card application:
The PTC referenced in the ARPC Response Code in Issuer Authentication Data is not used to update the BTC.
ICC Public Key pair or PIN Encipherment key pair must be personalized in order to encrypt the biometric data sent with the VERIFY command.
The CVM List should include Enciphered MOC Biometric CVM.
The BIT must be personalized in one of the records referenced in the AFL.

The Biometric (Verification Handler) Application on the card supports the following functionality:

1—Authenticate the requesting application for biometric verification to assure it is an authorized application on the card.

2—Receive the biometric verification request from the M/Chip Advance (Bio) application in a predefined format defined on the card level—other applications on the card should use the same format.

3—Verify the received biometric data using the predefined biometric matching algorithm. If successful, set BTC to BTL. If not successful, decrement BTC by 1.

4—Send the verification result to M/Chip Advance (Bio).

5—Send the remaining Biometric verification trials (BTC) to M/Chip Advance (Bio) if verification fails or when requested explicitly by M/Chip Advance (Bio).

6—Send Biometric Blocked SW1SW2 to M/Chip Advance (Bio) when verification fails and BTC=0.

7—Reset BTC upon receiving request from an authorized M/Chip Advance (Bio) application

8—Update the cardholder reference biometric verification data upon request from an authorized M/Chip Advance (Bio) application.

Modification of existing EMV features and process flows at the card will be described in more detail below with reference to FIGS. 8 to 13. The updates to conventional EMV processing at the card are summarised below:
General updates applied to most of the commands to clear flags used for biometric verification.
General Requirements updated to include biometric verification requirements.
State machine updated to introduce the new CLA values for VERIFY and PIN CHANGE/UNBLOCK commands to support command chaining.
Data Organization updated to include the new data elements relevant to biometric verification
First Generate AC updated to support biometric verification for transactions.
Second Generate AC updated to support biometric verification for transactions.
Get Data chapter updated to add the new supported tags used for biometric verification.
PIN CHANGE/UNBLOCK command updated to support MOC biometric verification.
VERIFY updated to support MOC biometric verification for transactions.
Data Dictionary updated with the new data objects.

Where significantly modified or where content is particularly relevant to the understanding of the content of this document, sections of EMV processing are discussed below. Other sections of are less significantly modified and other aspects of their operation are not relevant to the explanation of the functionality of modifications set out below, or will be readily apparent to the person skilled in the art.

Generally, the Chained Verify Flag and Chained PIN Change/Unblock Flag must be cleared at the beginning of some C-APDUs. An inter-applet interface is required when the Biometric Verification Handler is implemented as an application within the card. In which case, both the M/Chip Advance Bio application and Biometric Verification Handler must support an inter-applet interface to establish the required communication between the two applications. The inter-applet interface is implementation specific and implementation will be apparent to the person skilled in the art based on specific requirements. Existing state machine definitions are extended to include new CLA byte values for the VERIFY and PIN CHANGE/UNBLOCK commands in order to support command chaining—allowing command chaining supports extended biometric data when needed by specifying the required data retention mechanisms cross the different chained commands when needed.

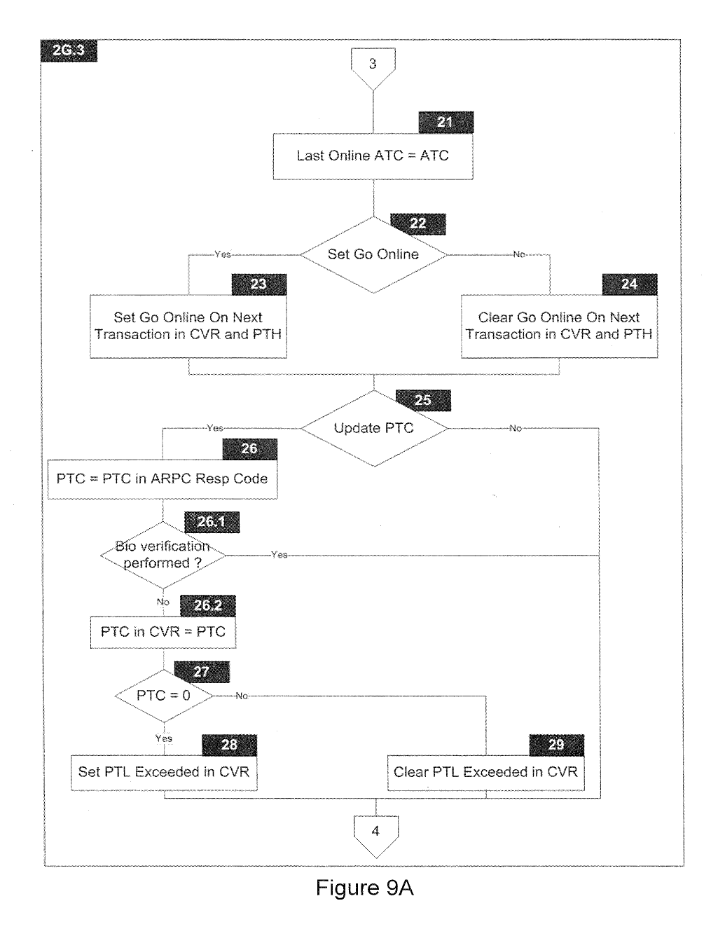

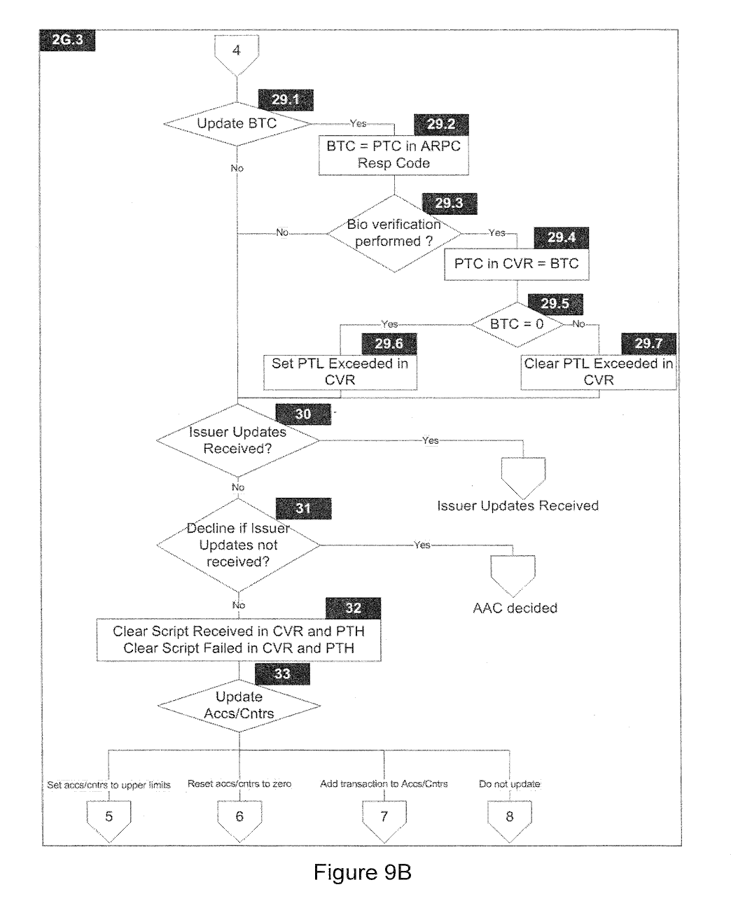

Modification of First and Second GENERATE AC commands to allow for biometric verification as a preferred option can be made by extending process flows as shown in FIG. 8 and FIGS. 9A and 9B respectively. In both cases, modification is required to indicate that biometric verification is an option and to establish use of the Biometric Try Counter and its relationship to the PIN Try Counter—more extensive modification is required to Second GENERATE AC flows, but the nature of the modifications will be entirely clear to the person skilled in the art familiar with EMV specifications.

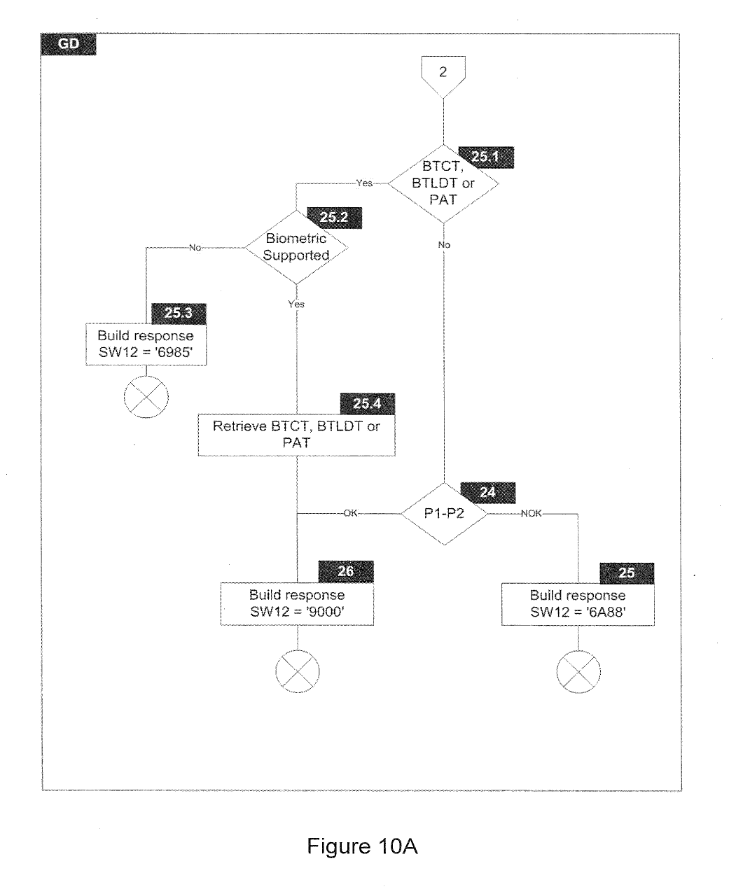

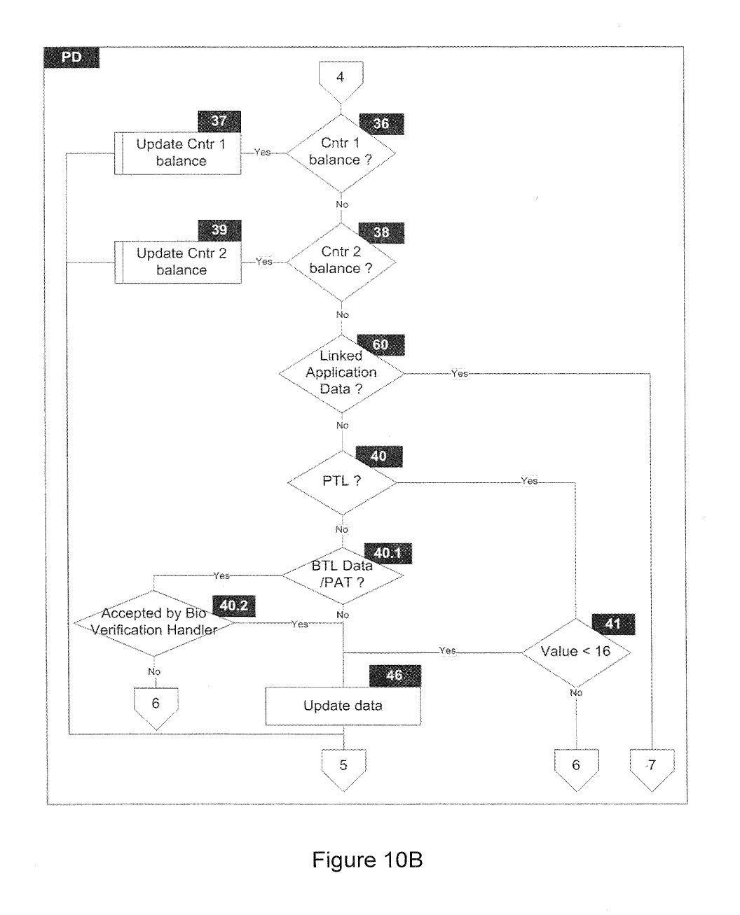

Modification of GET DATA process flows are shown in FIG. 10A. GET DATA is a command present in EMV specifications to allow specified data objects to be obtained from a card implementing the specification. The implementation of the command is extended to allow for biometric verification, in particular by adding Biometric Try Limit Data Template, Biometric Try Counters Template and Preferred Attempts Template and appropriate process flows. Modification of PUT data process flows are similar, and are shown in FIG. 10B. PUT DATA is an EMV command that allows specified data objects to be written to an EMV compliant card.

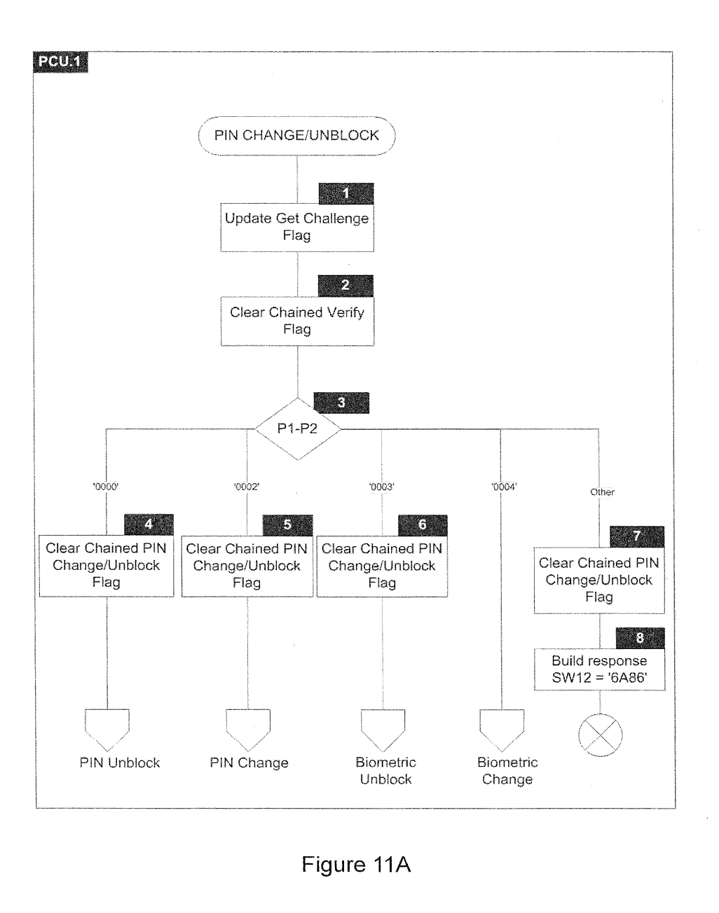

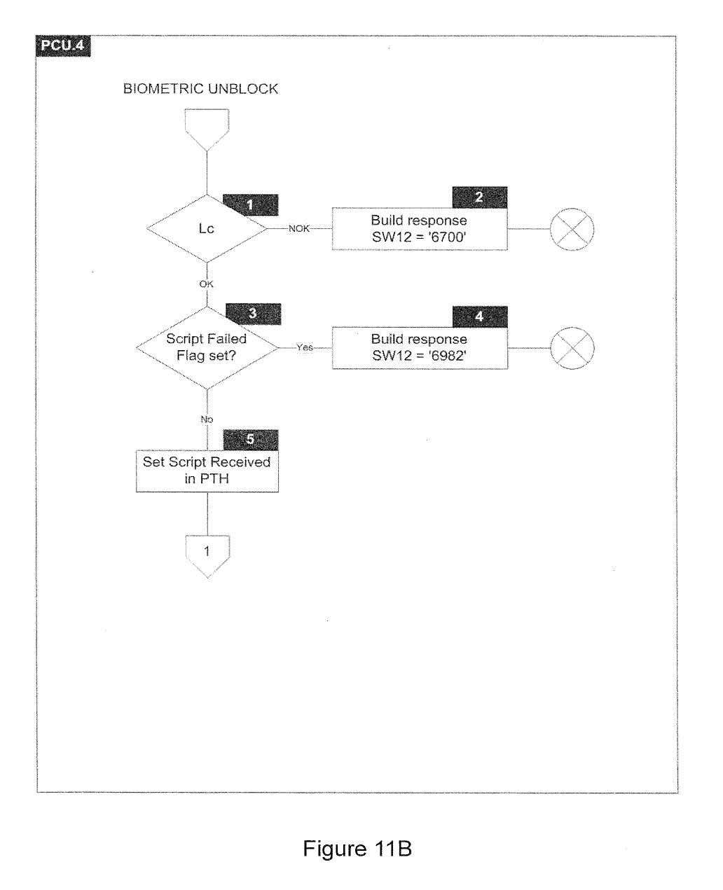

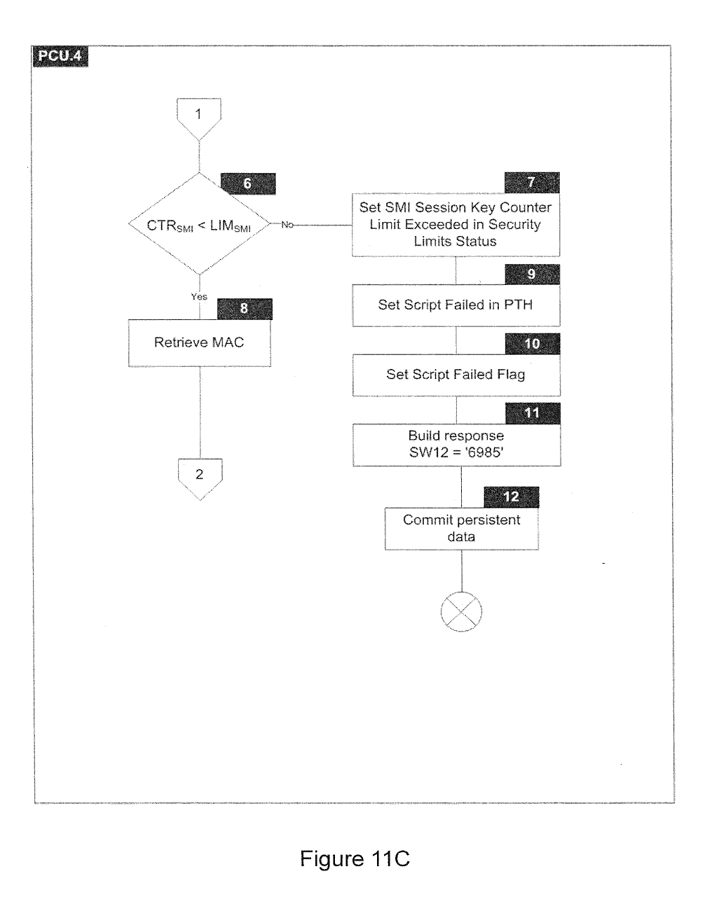

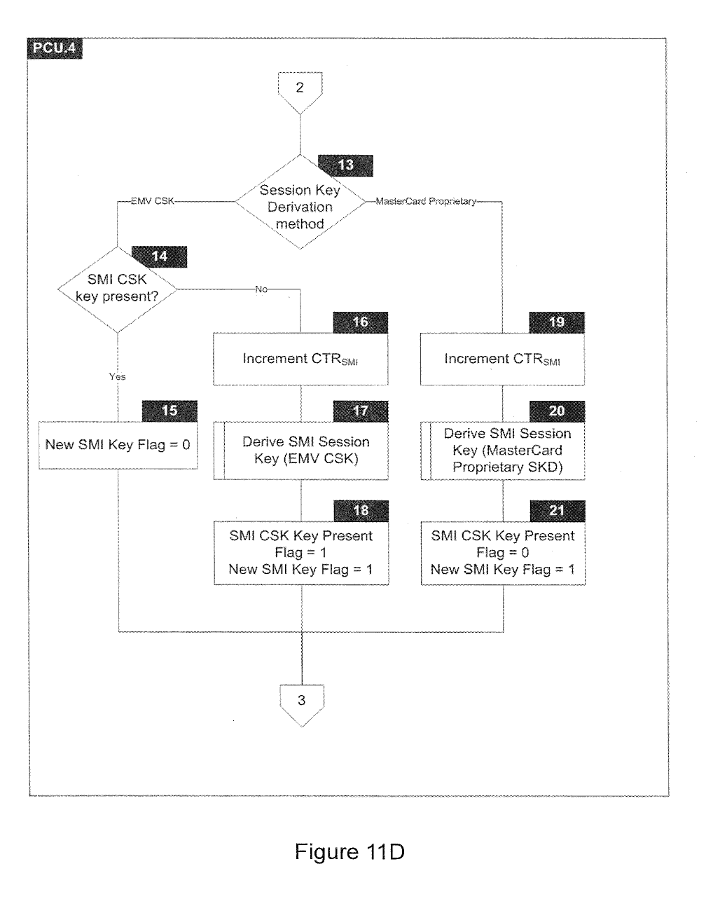

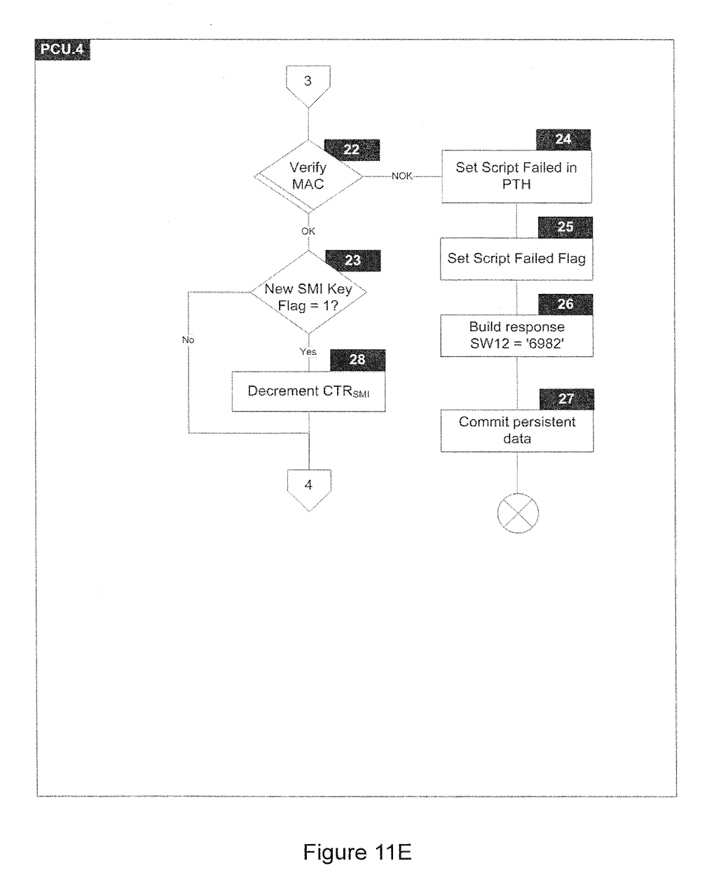

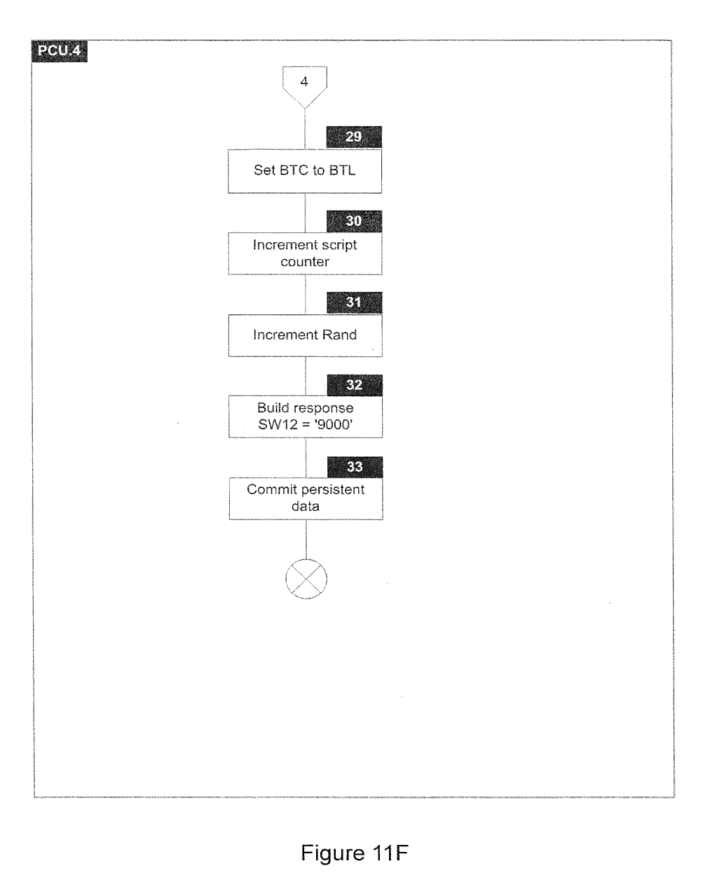

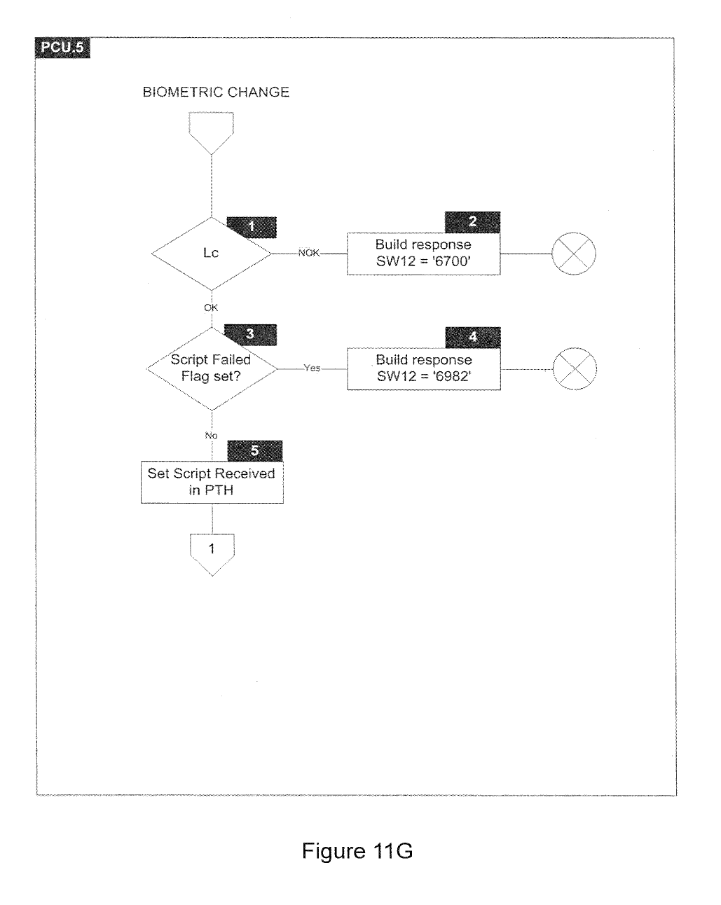

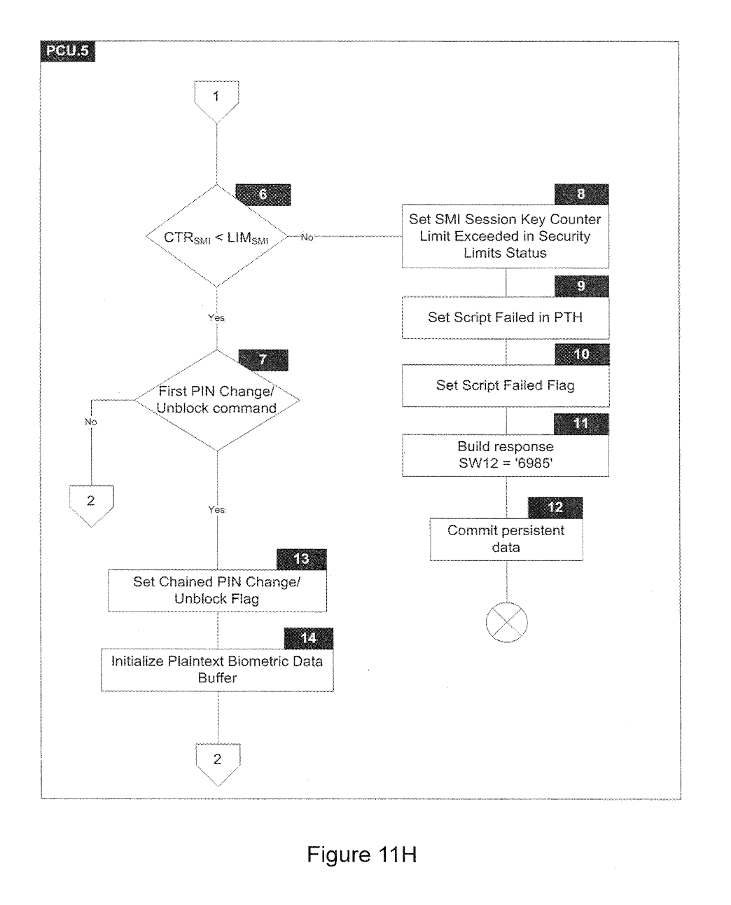

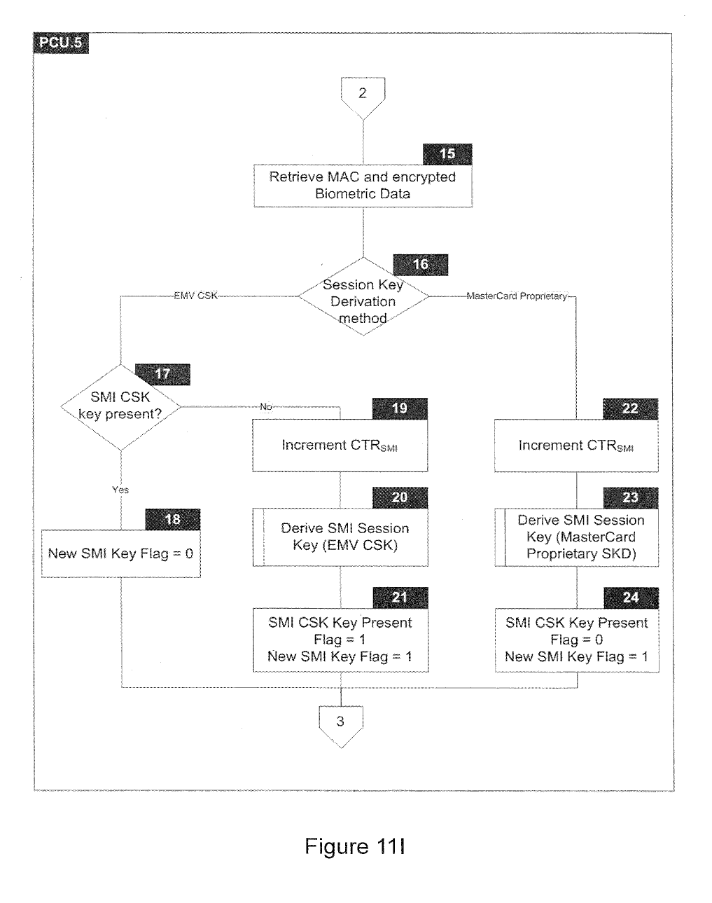

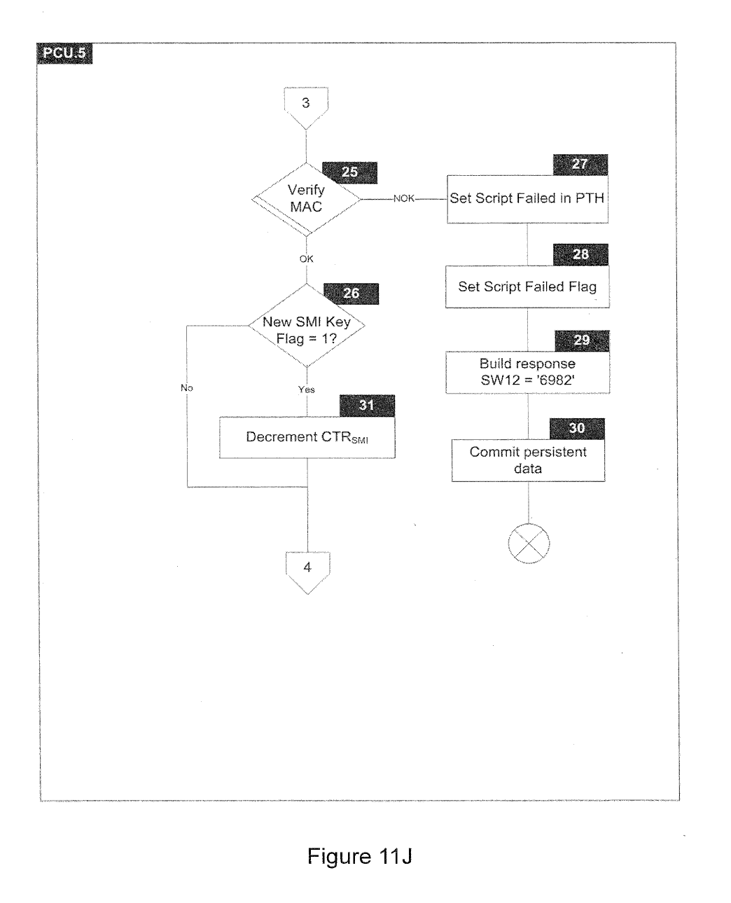

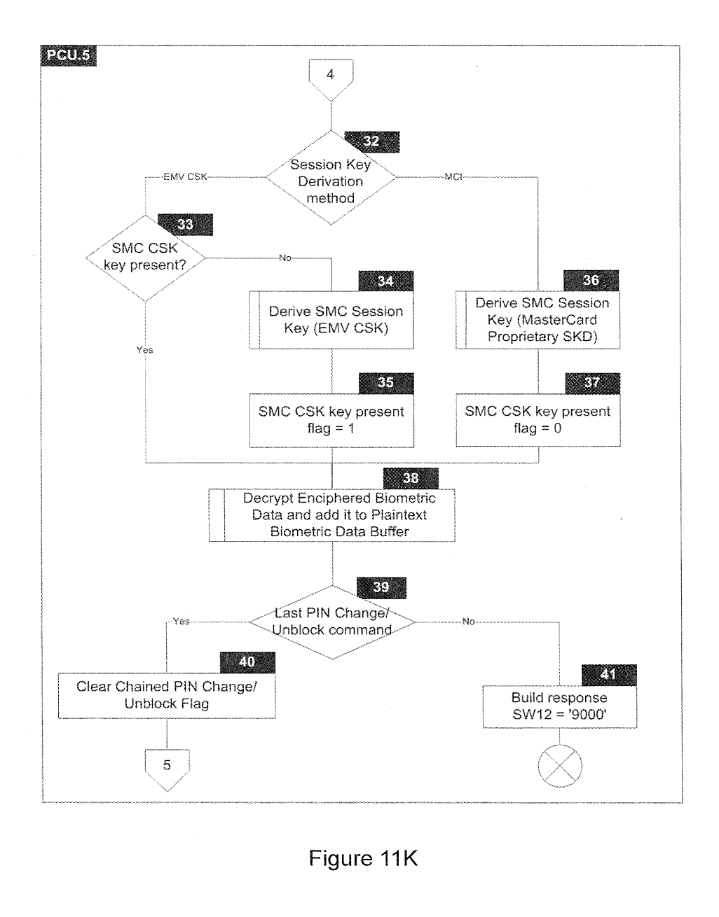

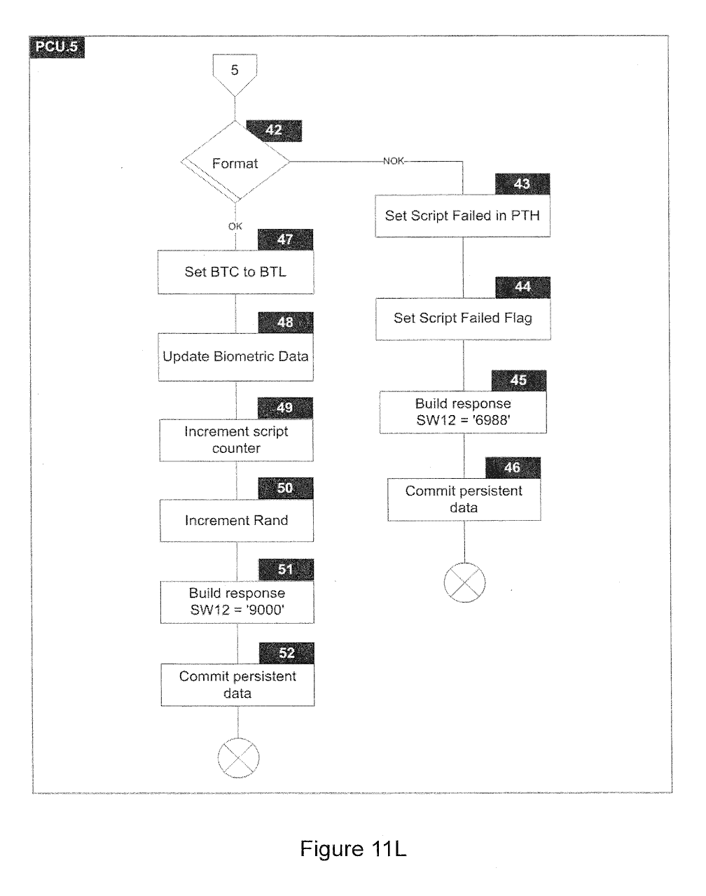

PIN CHANGE/UNBLOCK processing is shown in FIGS. 11A to 11L. PIN CHANGE/UNBLOCK command is provided in EMV specifications to allow PIN management. It is updated as described in this section to incorporate biometric verification as a preferred alternative to a PIN, but so as to allow fallback to a PIN if biometric verification is unavailable. This approach also allows chaining of certain commands so that they can be used in both biometric and PIN contexts. This command is significantly extended by this modification, so the full command process flow is shown.

This approach allows updating the biometric reference data of each or all biometric type supported by the card in implementation agnostic way. It also allows updating the biometric verification try limit and proffered attempts for each biometric type supported by the card in implementation agnostic way. The amended message structure is shown in Table 4 below.

TABLE 4
PIN CHANGE/UNBLOCK command message

| Code | Value |
|---|---|
| CLA | ‘84’ or ‘94’ |
| INS | ‘24’ |
| P1 | ‘00’ |
| P2 | ‘00’ for PIN Unblock |
| | ‘02’ for PIN Change |
| | ‘03’ for Biometric Unblock |
| | ‘04’ for Biometric Change |
| Lc | ‘08’ for PIN Unblock |
| | ‘10’ for PIN Change |
| | ‘09’ or ‘0B’ for Biometric Unblock |
| | Variable for Biometric Change |
| Data | PIN/Biometric Related Data |
| Le | Not present |

CLA = ‘94’ indicates that command chaining is used when the new biometric reference data does not fit in the data field of one command.

The main process flow is shown in FIG. 11A. Biometric Unblock processing is shown from FIGS. 11B to 11F and Biometric Change processing from FIGS. 11G to 11L. Specific details of implementation beyond this will be apparent to the person skilled in the art familiar with EMV specifications.

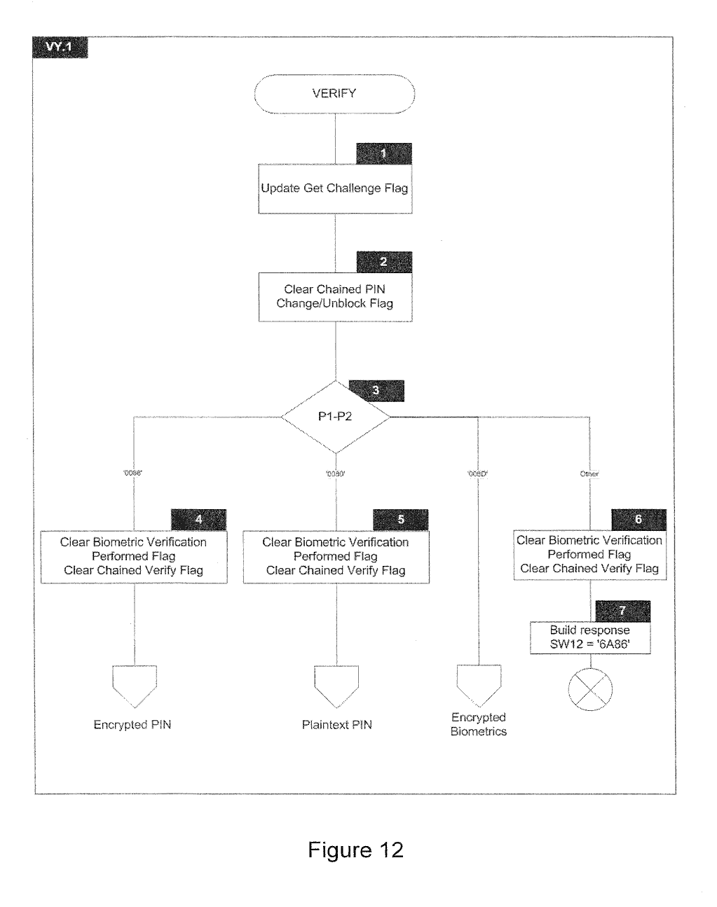

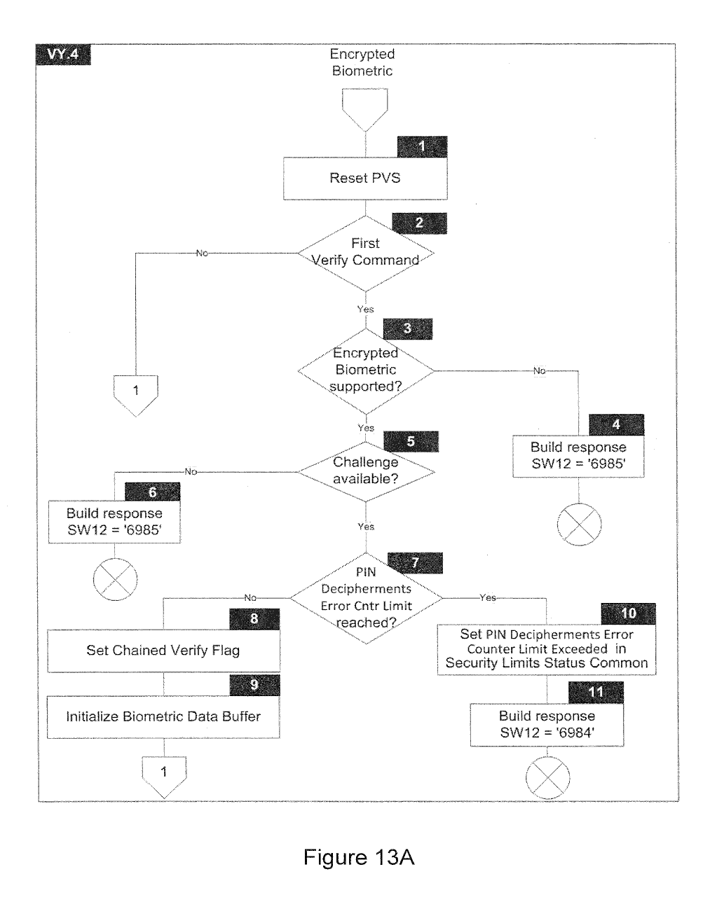

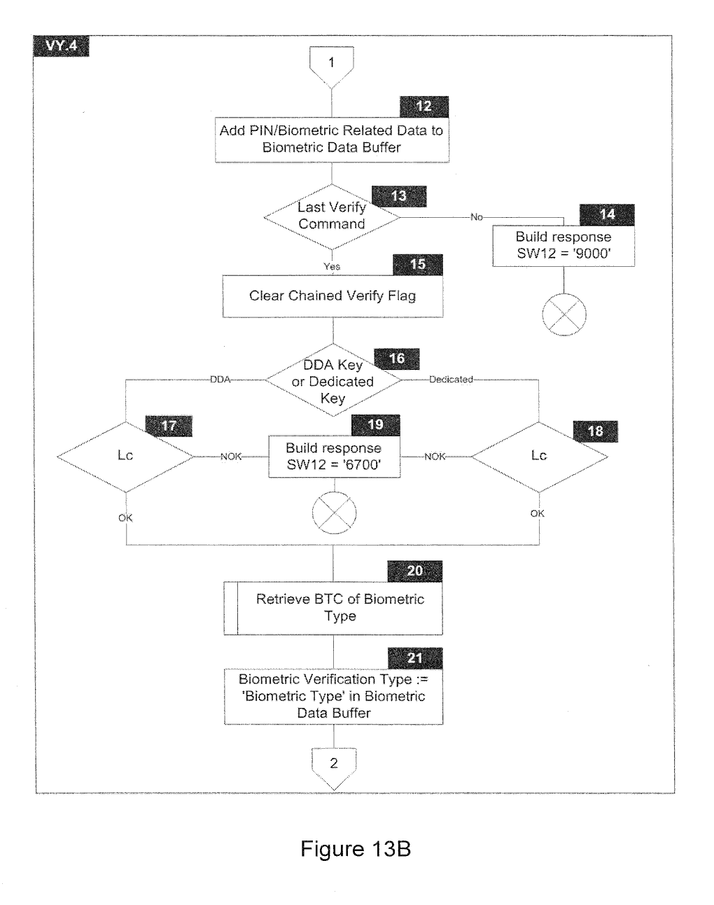

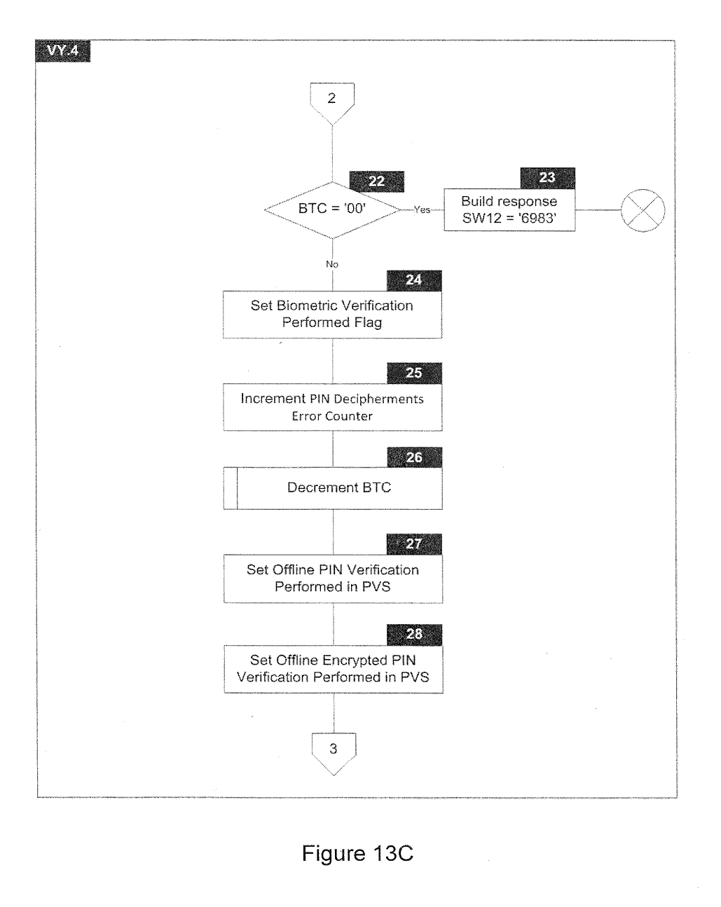

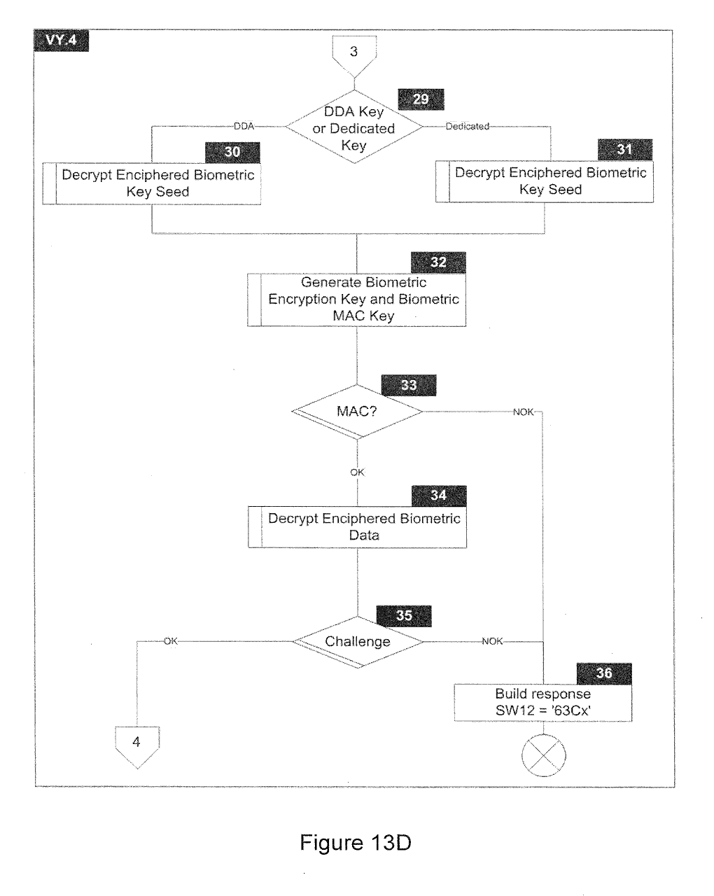

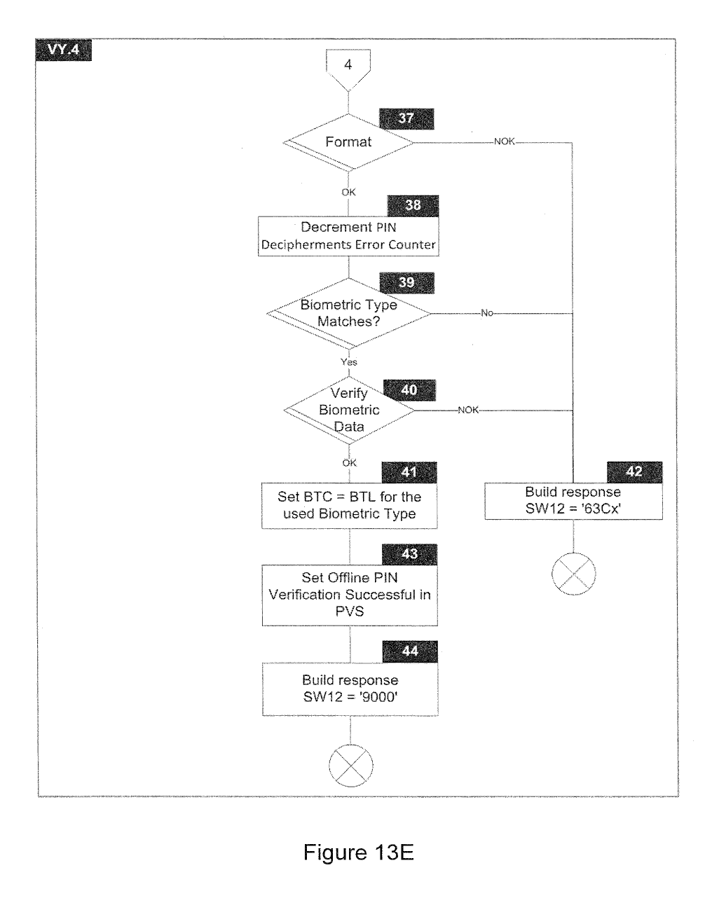

Modifications to the VERIFY command are shown in FIG. 12 and FIGS. 13A to 13E. The VERIFY command is provided in EMV specifications to allow cardholder verification. It is updated as described in this section to incorporate biometric verification as a preferred alternative to a PIN, but so as to allow fallback to a PIN if biometric verification is unavailable. This approach again allows chaining of certain commands so that they can be used in both biometric and PIN contexts. This command is again significantly extended by this modification, with extensions shown in FIG. 12 which indicates the main VERIFY logic and FIGS. 13A to 13E, which set out process flows where encrypted biometrics are employed. Again, specific details of implementation beyond this will be apparent to the person skilled in the art familiar with EMV specifications.

The specific implementation of the disclosure described in detail here does not limit the spirit and scope of the disclosure set out here. As the person skilled in the art will appreciate, while the implementation described in detail here relates to transaction processing using EMV protocols, other implementations of the disclosure as broadly described may be employed to other protocols, and other systems in which biometric verification by matching against data held in a user token may be employed.

### ACRONYMS AND ABBREVIATIONS

The following acronyms and abbreviations are used in the discussion above.

| Reference | Description |
|---|---|
| AC | Application Cryptogram |
| AFL | Application File Locator |
| AIP | Application Interchange Profile |
| APP | Application |
| b | Binary |
| BHT | Biometric Header Template |
| BIT | Biometric Information Template |
| BIO | Biometric |
| BTC | Biometric Try Counter |
| BTCT | Biometric Try Counter Template |
| BTL | Biometric Try Limit |
| BTLDT | Biometric Try Limit Data Template |
| CBEFF | Common Biometric Exchange Formats Framework |
| CDA | Combined DDA/AC Generation |
| CLA | Class byte of command message |
| CVM | Card Verification Method |
| CVR | Card Verification Results |
| DDA | Dynamic Data Authentication |
| DO | Data Object |
| EMV | Europay MasterCard Visa |
| ICC | Integrated Circuit Card |
| IFD | International Framework for Dictionaries |
| INS | INS |
| ISO | International Organization for Standardization |
| Lc | Number of bytes present in the data field of the C-APDU |
| MOC | Match On Card |
| PAT | Preferred Attempts Template |
| PIN | Personal Identification Number |
| POS | Point of Sale |
| P1 | Parameter 1 |
| P2 | Parameter 2 |
| PTC | PIN Try Counter |
| RFU | Reserved for Future Use |
| SDA | Static Data Authentication |
| SW1 | Status Byte One |
| SW2 | Status Byte Two |
| TVR | Terminal Verification Results |

1. A method of biometric verification, the method comprising interaction between a token having stored user biometric data held thereon or accessible therethrough and a terminal having a biometric reader associated therewith, the method comprising:
capturing user biometric data at the biometric reader;
the token initiating comparison of the captured user biometric data with the stored user data to determine a match; and
the token providing a verification result to the terminal, wherein an action at the terminal may proceed if the verification result indicates a match between the captured user biometric data and the stored biometric data.

2. The method of claim 1, wherein the comparison step takes place at the token, and the token obtains the verification result and returns it to the terminal.

3. The method of claim 2, wherein the token comprises a biometric verification application invoked by a transaction application on the token for interacting with the terminal.

4. The method of claim 1, wherein the token and the terminal first determine whether both support biometric verification.

5. The method of claim 1, wherein the captured biometric data is enciphered for transmission from the terminal.

6. The method of claim 1, wherein the method is performed in a transaction system and biometric verification is performed to verify a customer to a transaction.

7. The method of claim 6, wherein the token is a payment card and biometric verification is performed to verify the cardholder of the payment card.

8. The method of claim 7, wherein the token and the terminal are adapted to perform transactions according to EMV protocols.

9. The method of claim 8, wherein biometric verification is provided as a customer verification method.

10. The method of claim 9, wherein if either the payment card or the terminal does not support biometric verification, PIN is used as a fallback to biometric verification.

11. A method of biometric verification at a token having stored user biometric data held thereon and capable of performing data processing, the method comprising:
receiving captured user biometric data from a terminal;
initiating comparison of the captured user biometric data with the stored user data to determine a match; and
providing a verification result to the terminal.

12. The method of claim 11, wherein the comparison step takes place at the token, and the token obtains the verification result and returns it to the terminal.

13. The method of claim 12, wherein the token comprises a biometric verification application invoked by a transaction application on the token for interacting with the terminal.

14. The method of claim 11, wherein the method is performed in a transaction system and biometric verification is performed to verify a customer to a transaction, wherein the token is a payment card and biometric verification is performed to verify the cardholder of the payment card.

15. The method of claim 14, wherein the token and the terminal are adapted to perform transactions according to EMV protocols.

16. The method of claim 15, wherein biometric verification is provided as a customer verification method.

17. A method of biometric verification at a terminal by interaction with a token having stored user biometric data held thereon or accessible therethrough, the terminal having a biometric reader associated therewith, the method comprising:
capturing user biometric data at the biometric reader;
providing the captured user biometric data to the token for comparison of the captured user biometric data with the stored user data to determine a match; and
receiving a verification result from the token and enabling an action at the terminal to proceed if the verification result indicates a match between the captured user biometric data and the stored biometric data.

18. The method of claim 17, wherein the biometric reader is integrated within the terminal.

19. The method of claim 17, wherein the method is performed in a transaction system and biometric verification is performed to verify a customer to a transaction, wherein the token is a payment card and biometric verification is performed to verify the cardholder of the payment card.

20. The method of claim 19, wherein the token and the terminal are adapted to perform transactions according to EMV protocols and wherein biometric verification is provided as a customer verification method.
